(19) United States
(12) Patent Application Publication
(10) Pub. No.: US 2010/0023882 A1
(43) Pub. Date: Jan. 28, 2010

(54) Crime alert method and apparatus

(76) Inventor: Cecil R. Jackson, Chandler, AZ (US)

Correspondence Address: TOD R NISSLE, PO BOX 55630, PHOENIX, AZ, 85078, US

(21) Appl. No.: 12/387,474

(22) Filed: Apr. 30, 2009

Related U.S. Application Data
(63) Continuation of application No. 11/545,817, filed on Oct. 10, 2006, now abandoned.
(60) Provisional application No. 60/725,367, filed on Oct. 11, 2005.

(51) Int. Cl. G06F 3/01

(52) U.S. Cl. 715/760

(57) ABSTRACT

A process for reducing crime in schools includes the steps of providing an Internet web site adapted to permit the reports of crimes; using the web site to report a crime; and passing on a crime report to the web site to law enforcement authorities.

This application claims priority based on a Provisional Patent Application No. 60/726,367 filed Oct. 11, 2005 and a continuation of U.S. patent application Ser. No. 11/545,817 filed Oct. 10, 2006.

This application relates to a process for reducing crime in schools and communication.

The process utilizes an Internet web site and permits students to anonymously report when they are aware of a crime or believe a crime has been or will be committed. After a student in an elementary school, middle school, high school, college, or other school anonymously reports to the web site a crime and the location of the crime, the report is promptly passed on to selected local, city, state and/or federal personnel to investigate the crime. These personnel can include firefighters, police officers, EMS workers, student resource officers (SROs), state and federal law enforcement officers, and other selected officials that can facilitate responding to a crime reported by students at a web site.

The process of the invention also permits a student to use his or her cell phone to text message to Alerts@alertrecall.com or to another address or phone number a message indication the location of a crime. By way of example, not to limitation, the text message (or message left by a student at the Internet web site) typically includes the seriousness of the crime or importance of promptly reaction to the crime, school name, state specific location of crime (if known), time crime was or will be committed (if known), and crime or activity being reported. A numerical scale can be used by the student to indicate the severity of the crime. The scale can be 1 to 5, with a being 1 being the most serious crime.

An example of a text message (or of a message sent via the Internet web site) is:

“1 Arizona Washington High School. Gang fight behind gymnasium.”

In the above message, the “1”indicates it is a serious crime. When the telephone text message feature is used, the confidentiality of the caller is maintained.

Printouts from an Internet web site utilizing the above procedures are attached hereto as Exhibit A, 19 pages including Alert Recall home page (1 of 1), Place an alert (page 1 of 1), Mission Statement, etc. (pages 1 of 2 to 2 of 2), SRO listing (pages 1 of 2 to 2 of 2), Alter Hero's (page 1 of 1), a new way to initiate an Alert has arrived (page 1 of 1), Alert News (pages 1 of 10 to 10 of 10), and Parents alert (page 1 of 1).

Parents can also utilize the Internet web site to report crime.

Having described my invention in such terms as to enable those of skill in the art to understand practice the invention, and having described the presently preferred embodiments thereof,

I Claim:

1. A process for reducing crime in schools, comprising the steps of
a. providing an Internet web site adapted to permit the reporting of crimes;
b. using said web site to report a crime; and,
c. passing on a crime report from said web site to law enforcement authorities.
